(19) United States
(12) Patent Application Publication
(10) Pub. No.: US 2024/0184604 A1
(43) Pub. Date: Jun. 6, 2024

(54) CONSTRAINING GENERATION OF AUTOMATED ASSISTANT SUGGESTIONS BASED ON APPLICATION RUNNING IN FOREGROUND

(71) Applicant: GOOGLE LLC, Mountain View, CA (US)

(72) Inventor: Keun Soo Yim, San Jose, CA (US)

(21) Appl. No.: 18/075,191

(22) Filed: Dec. 5, 2022

(51) Int. Cl. G06F 9/451; G06F 3/04842

(52) U.S. Cl. CPC G06F 9/453; G06F 3/04842

(57) ABSTRACT

Implementations detect an assistant invocation while a first application is running in a foreground of a client device, and retrieve one or more suggestion-generation criteria for the first application. Those implementations further determine, based on the retrieved one or more suggestion-generation criteria, one or more suggestions to be presented to a user of the client device in response to the assistant invocation. Some implementations additionally cause the one or more suggestions to be displayed in response to the assistant invocation, such as within an overlay displayed over a user interface of the first application.

### BACKGROUND

Users frequently utilize applications (e.g., browsers, smart device control apps, mapping apps, social media apps, etc.), to obtain information (e.g., news, posts, driving directions), to perform in-app action(s) (e.g., controlling smart device(s), navigating to a destination, ordering item(s)), and/or for other purposes.

While interacting with a given application of a client device, a user can access an additional application of the client device, that is distinct and separate from the given application, to obtain additional information that is pertinent to their interaction with the given application but not available in the given application and/or to perform additional action(s) that are pertinent to their interaction with the given application not performable via the given application. However, a large quantity of user inputs can be required for the user to locate and launch the additional application and to obtain the additional information and/or to perform the additional action(s) within the additional application. Moreover, the user may need to switch back and forth between the given application and the additional application to extract information, from the given application, for use in obtaining the additional information and/or performing the additional action(s) within the additional application. Such large quantity of user inputs and/or switching back and forth can prolong interaction of the user with the client device and cause excess utilization of battery, processor, and/or other resources of the client device. Further such large quantity of user inputs and/or switching back and forth can be difficulty for users with limited dexterity and/or cumbersome on various client devices, such as those with small displays.

### SUMMARY

Implementations disclosed herein relate to generating, by an automated assistant application (sometimes referred to as “automated assistant”), one or more suggestions and causing, by the automated assistant application, the suggestion(s) to be displayed within an overlay of a user interface of a foreground application that is separate from the automated assistant application and that is running in a foreground of a client device. Each of the generated and displayed suggestion(s) can be selectable, and when selected, can cause corresponding additional information to be provided and/or corresponding additional action(s) to be performed. The additional information and/or the additional action(s) that are provided and/or performed in response to selection of a suggestion can be provided and/or performed by an additional application (that is in addition to the automated assistant application and the foreground application). Such providing and/or performance can be via the overlay of the user interface of the foreground application, or through fully launching the additional application, thereby making the additional application the foreground application. Further, one or more of the suggestion(s) can be generated so that their corresponding additional information and/or additional action(s) are pertinent to a current and/or recent state of the foreground application.

In generating suggestion(s), various implementations utilize suggestion-generation criteria that are specific to the foreground application, and optionally specific to a current state of the foreground application. The suggestion-generation criteria can be provided directly or indirectly by the foreground application and can specify constraint(s) to be utilized by the automated assistant application in generating and/or displaying suggestion(s). For example, given suggestion-generation criteria can specify type(s) of action(s) that should be used or should not be used in generating suggestion(s), and/or can specify particular additional application(s) that should be used or should not be used in generating suggestion(s). Accordingly, provision of suggestion-generation criteria by the foreground application enables the foreground application to constrain suggestion generation by the automated assistant when the foreground application is in the foreground, while still enabling suggestion generation to be performed by the automated assistant. In these and other manners, the foreground application can exercise a degree of influence over the suggestion(s) that are generated and/or displayed by the automated assistant while the foreground application is in the foreground

Enabling the foreground application to provide the suggestion-generation criteria and having the automated assistant adhere to the suggestion-generation criteria can achieve various technical benefits. As one example, given suggestion-generation criteria, for a state of a foreground application, can be provided by the foreground application so as to prevent interruption and/or prolonging of an interaction with the foreground application and/or so as to prevent generation of suggestion(s) for app(s) and/or action(s) that are not compatible with the state of the foreground application. Further, the given suggestion-generation criteria can be created utilizing information that is available and/or interpretable by the foreground but that may not be available (e.g., due to privacy or other restrictions on data transfer) and/or interpretable by the automated assistant application. Accordingly, the utilization of suggestion-generation criteria can overcome data transfer restrictions and/or overcome the inability of the automated assistant application to interpret certain information.

As a particular example, assume the foreground application is a restaurant reservation application that a user can interact with to browse restaurants, select a given restaurant and, once a given restaurant is selected, provide various inputs to book a particular reservation with the restaurant. In order to prevent interruption and/or prolonging of booking a reservation via the foreground application, the foreground application can provide, during booking of a reservation via the foreground application, first suggestion-generation criteria that prevent certain type(s) of suggestion (or even any suggestions) from being generated or displayed by the automated assistant application. For example, the first suggestion-generation criteria can prevent suggestion(s) for any ridesharing aps (e.g., a suggestion that, when selected, executes a deeplink for the ridesharing app that is specific to the restaurant). This can prevent provision and selection of ridesharing suggestion(s) that can cause booking of the reservation via the foreground application to be prolonged and/or interrupted. However, upon completion of a reservation via the foreground application, the foreground application can provide second suggestion-generation criteria that no longer restrict (or even require) generation and display of ridesharing suggestion(s).

As another particular example, assume the foreground application is an application of a retail store that a user can interact with to purchase items at the store. Further assume the store has an agreement with a first delivery service that enables the first delivery service to pick up purchased items on behalf of a purchaser, and deliver them to the purchaser—but lacks agreements with any other delivery services thereby preventing any other delivery service from picking up purchased items and delivering them. In such a situation, the foreground application can provide suggestion-generation criteria that restricts generation and/or display of suggestion(s) for the other delivery service(s) and/or that requires generation and/or display of suggestion(s) for the first delivery service. In these and other manners, the suggestion-generation criteria can prevent the automated assistant from wastefully generating and/or displaying suggestion(s) for other deliver service(s) that, if interacted with, would not enable purchased items to be picked up and delivered.

As yet another particular example, assume the foreground application is a music streaming application that a user can interact with to stream music. When the foreground application is streaming music by an artist that has one or more first user-specific characteristics, accessible to the foreground application but not to the automated assistant, the foreground application can provide first suggestion-generation criteria. However, when the foreground application is streaming music by an artist that does not have the first user-specific characteristic(s) and/or that has second user-specific characteristic(s), the foreground application can provide alternate second suggestion-generation criteria. For example, the first suggestion-generation criteria can be provided when the foreground application determines that the artist, of currently streaming music, is an artist that the user frequently listens to within the foreground application and/or has favorited within the foreground application. Also, for example, the second suggestion-generation criteria can be provided when the foreground application determines that the artist, of currently streaming music, is not an artist that the user frequently listens to within the foreground application and/or has not favorited within the foreground application. For instance, the first suggestion-generation criteria can specify action(s) and/or application(s) associated with booking concert ticket(s) should be provided whereas the second suggestion-generation criteria can not specify that action(s) and/or application(s) associated with booking concert ticket(s) should be provided.

In some implementations, after the one or more suggestions are displayed within the overlay of the foreground application that is running in the foreground, a user of the client device can select a particular suggestion (of the one or more suggestions) that, for instance, suggests a corresponding action to be performed by a particular application distinct from the foreground application. In this case, the corresponding action can be performed in response to the particular suggestion being selected, and the overlay can be removed from the user interface of the foreground application in response to the corresponding action being performed or completes.

In some implementations, as a non-limiting example, the suggestion-generation criteria can be, or include, a rule that defines content or action(s) that are not allowed by the foreground application that is running in the foreground of the client device. As another non-limiting example, the suggestion-generation criteria can be, or include, a rule that defines one or more applications (and/or content or action from the one or more applications) that are not allowed by the foreground application. By allowing the foreground application to control or select application(s) that are allowed to be source(s) of the information or action(s) to be displayed/suggested within the overlay of the user interface of the foreground application, the user can acquire information or perform action(s) from source(s) that are additional to the foreground application, while staying in the foreground application without having to leave the foreground application to access such source(s). As a result, consumption of the computing resources of the client device can be reduced, and user experience can be improved through this cross-app interaction that is realized within the user interface of a single application (i.e., the foreground application that is running in the foreground of the client device).

In various implementations, an automated assistant application can be invoked while the foreground application is running in the foreground, where the automated assistant application can be used to determine/retrieve the suggestion-generation criteria that is specific to the foreground application. In some implementations, after being invoked, the automated assistant application can retrieve a foreground context of the client device, to identify the foreground application that is running in the foreground of the client device. In these implementations, based on the identified foreground application, the automated assistant application can, for instance, access a database to retrieve the aforementioned suggestion-generation criteria, where the database stores a plurality of suggestion-generation criteria each specific to a corresponding application, of a plurality of applications. Alternatively or additionally, based on the identified foreground application, the automated assistant application can communicate with the identified foreground application to retrieve the suggestion-generation criteria that is specific to the identified foreground application.

In some other implementations, after the automated assistant application is invoked, the foreground application can initiate an action of forwarding the suggestion-generation criteria that is specific to the foreground application, to the automated assistant application, for the automated assistant application to determine the one or more suggestions based at least on the suggestion-generation criteria and/or a state (current or recent) of the foreground application.

As a working example, a user of a client device (e.g., a smart phone) is listening to song A (produced by singer X) using a music application that is running in a foreground of the client device. A user interface of the music application can include a selectable element (e.g., button) that, when selected (e.g., via touch-control, click, or audibly), causes an automated assistant application to be invoked, where the automated assistant application is invoked to display an overlay that includes one or more suggestions and that covers a portion of the user interface. The one or more suggestions can be, or include, a suggestion (e.g., in natural language) that suggests an action which can be, for instance, an Internet search (e.g., “How old is singer X” or “What about singer Y”). Alternatively or additionally, the one or more suggestions can be, or include, a suggestion (in natural language) that suggests an additional action which can be, for instance, ticket purchase (e.g., “Singer X is to perform song A at concert Z, buy ticket?” or “Singer X is to perform song A at concert Z, buy a ticket using Ticket_1?”). It's noted that in some circumstances, instead of being invoked via user selection of the selectable element, the automated assistant application can be invoked in response to the user squeezing the client device, in response to the user pressing a hardware button on the client device (e.g., long press of a power button, or in response to the user speaking an invocation phrase such as “OK Assistant”.

In this working example, the one or more suggestions can be determined by the automated assistant application based on suggestion-generation criteria that is specific to the music application (i.e., the aforementioned foreground application) which is running in the foreground of the client device. For instance, the client device can be installed with, or access, a first ticketing application Ticket_1 and a second ticketing application Ticket_2. In this case, if the suggestion-generation criteria includes a rule defining that suggestion(s) suggesting action(s) performable via the first ticketing application Ticket_1 are enabled/allowed to be shown within the overlay of the music application while suggestion(s) suggesting action(s) performable via the second ticketing application Ticket_2 are disabled to be shown within the overlay, the automated assistant application can, for instance, correspondingly determine or generate a suggestion of “Singer X is to perform song A at concert Z, buy ticket using Ticket_1” for display within the overlay, instead of determining or generating a suggestion of “Singer X is to perform song A at concert Z, buy ticket using Ticket_2” for display within the overlay.

Alternatively, the suggestion-generation criteria can include a first rule defining that suggestion(s) suggesting action(s) of ticket purchase is disabled to be shown within the overlay, and/or a second rule defining that suggestion(s) suggesting action(s) of Internet search is enabled to be shown within the overlay. In this situation, the automated assistant application can correspondingly determine or generate a suggestion in natural language, e.g., “How old is singer X” or “What about singer Y”, instead of determining or generating a suggestion of “Singer X is to perform song A at concert Z, buy ticket using Ticket_1”.

Optionally, instead of or in addition to a suggestion suggesting an action, the one or more suggestions can include a suggestion that suggests content or other information.

After determining or generating the one or more suggestions, the automated assistant application can cause the one or more suggestions to be displayed within the overlay of the music application that is running in the foreground of the client device, for selection by the user. For instance, the user can select a suggestion suggesting “Singer X is to perform song A at concert Z, buy a ticket using Ticket_1?”. In response to the user selecting the suggestion that suggests “Singer X is to perform song A at concert Z, buy ticket using Ticket_1?”, the overlay can be updated to display ticket information provided by the first ticketing application Ticket_1, where the ticket information can enable the user to select and add a ticket to a cart of the first ticketing application Ticket_1. In this case, the overlay can be further updated to display the cart of the first ticketing application, thereby allowing the user to check out the ticket that is added to the cart.

If the user checks out the ticket and completes a purchase order of the ticket, the overlay can be yet further updated to display order confirmation information, or to be dismissed (e.g., automatically) so that the overlay is no longer displayed to cover the aforementioned portion of the user interface of the music application. If the user decides not to check out or the user does not add a ticket to the cart, the overlay can also be dismissed (e.g., manually by the user). For instance, the user can swipe to dismiss the overlay, click an exit button that removes the overlay from being displayed, or via other approaches (e.g., automatic dismissal after being displayed for a certain period of time, without receiving user input or interaction).

Continuing with the above working example, optionally, in response to being invoked (e.g., via the music application), the automated assistant application can retrieve the aforementioned suggestion-generation criteria from the music application, and determine, based at least on the retrieved suggestion-generation criteria, the aforementioned one or more suggestions to be displayed in response to the invocation of the automated assistant application.

Alternatively, in response to being invoked, the automated assistant application can retrieve a foreground context of the client device indicating that the music application is running in the foreground. In this case, the automated assistant application can access a database storing different suggestion-generation criteria for corresponding applications, where the database, for instance, can be a table (see table 300A in FIG. 3A, or table 300B in FIG. 3B) indexed with application names and one or more rules forming the suggestion-generation criteria for applications (e.g., including the music application) to which the application names correspond. For instance, using the table, the automated assistant application can retrieve one or more rules forming the suggestion-generation criteria for the music application, and determine, based at least on the retrieved suggestion-generation criteria, the aforementioned one or more suggestions to be displayed in response to the invocation of the automated assistant application.

The above is provided merely as an overview of some implementations. Those and/or other implementations are disclosed in more detail herein.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

The above and other aspects, features, and advantages of certain embodiments of the present disclosure will be more apparent from the following description taken in conjunction with the accompanying drawings. In the drawings:

FIG. 1 depicts a block diagram of an example environment that demonstrates various aspects of the present disclosure, and in which implementations disclosed herein may be implemented.

FIG. 2A depicts an example user interface of an application running in a foreground of a client device, in accordance with various implementations.

FIG. 2B depicts an example user interface of the application in FIG. 2A that includes an overlay to display one or more suggestions, in accordance with various implementations.

FIG. 2C depicts an example user interface that includes the overlay that is updated in response to user selection of a suggestion of the one or more suggestions in FIG. 2B, in accordance with various implementations.

FIG. 2D depicts an example user interface that includes the overlay that is further updated in response to user input subsequent to the user selection of the suggestion in FIG. 2C, in accordance with various implementations.

FIG. 2E depicts an example user interface that includes the overlay that is additionally updated in response to additional user input, in accordance with various implementations.

FIG. 3A depicts an example database storing suggestion-generation criteria for a plurality of applications, in accordance with various implementations.

FIG. 3B depicts another example database storing suggestion-generation criteria for a plurality of applications, in accordance with various implementations.

FIG. 4 illustrates a flowchart illustrating an example method for generating one or more suggestions for display within an overlay of a particular application based on suggestion-generation criteria specific to the particular application, in accordance with various implementations.

FIG. 5 is a flowchart illustrating an additional example method for generating one or more suggestions, in accordance with various implementations.

FIG. 6 illustrates an example architecture of a computing device, in accordance with various implementations.

### DETAILED DESCRIPTION

The following description with reference to the accompanying drawings is provided for understanding of various implementations of the present disclosure. It's appreciated that different features from different embodiments may be combined with and/or exchanged for one another. In addition, those of ordinary skill in the art will recognize that various changes and modifications of the various embodiments described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

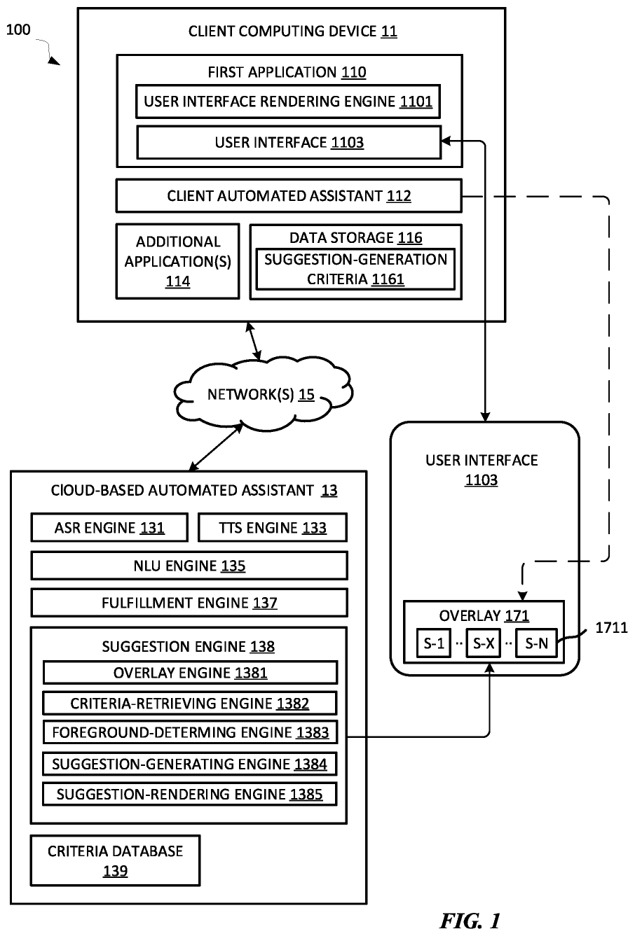

FIG. 1 is a block diagram of an example environment 100 that demonstrates various aspects of the present disclosure, and in which implementations disclosed herein may be implemented. As shown in FIG. 1, the environment 100 can include a client computing device 11 (may be referred to simply as “client device”) that includes a first application 110. Optionally, the client computing device 11 can further include a client automated assistant application 112 (may be referred to as “client automated assistant”), one or more additional applications 114, and a data storage 116. The client computing device 11 can be in communication with one or more servers (not shown) via one or more networks 15. For instance, a server, of the one or more servers, can include a cloud-based automated assistant application 13 (or certain components thereof), where the client automated assistant application 112 can communicate with the cloud-based automated assistant application 13 via the one or more networks 15.

The client computing device 11 can be, for example, a cell phone, a laptop, a desktop, a notebook computer, a tablet, a smart TV, a messaging device, or a personal digital assistant (PDA), and the present disclosure is not limited thereto. The server computing device 13 can be, for example, a web server, a proxy server, a VPN server, or any other type of server as needed. The one or more networks 15 can include, for example, a local area network (LAN), a wide area network (WAN) such as the Internet, and/or any other appropriate network.

In various implementations, the first application 110 can include a user interface rendering engine 1101 to render a user interface 1103 via the client computing device 11. The first application 110, for instance, can be a social media application, a music application, a messaging application, a browser application, or any other applicable application installed at (or accessible via) the client computing device 11. In various implementations, the one or more additional applications 114 can be any applicable application(s) that are different from the first application 110. For instance, the one or more additional applications 114 can include a calendar application, a movie ticket application, or any other applicable application.

In various implementations, the data storage 116 can include instructions, metadata associated with the first application 110 and/or the additional application(s) 114, or other data (e.g., user preference data). The metadata associated with the first application 110 can include, for instance, suggestion-generation criteria 1161 that is specific to the first application 110, which will be described in more detail later in this disclosure.

In various implementations, the cloud-based automated assistant application 13 (or similarly the client automated assistant application 112) can have a plurality of components including an automatic speech recognition (ASR) engine 131, a text-to-speech (TTS) engine 133, a natural language understanding (NLU) engine 135, and/or a fulfillment engine 137. The ASR engine 131 can process audio data that captures a spoken utterance to generate a speech recognition of the spoken utterance. The NLU engine 135 can determine semantic meaning(s) of audio (e.g., the aforementioned audio data capturing the spoken utterance) and/or a text (e.g., natural language content from a message or the aforementioned speech recognition that is converted by the ASR engine 131 from the audio data), and decompose the determined semantic meaning(s) to determine intent(s) and/or parameter(s) for an assistant action. For instance, the NLU engine 135 can process natural language content of “Weather today in Louisville?”, to determine an intent (e.g., Internet search) and/or parameters (e.g., search parameters including: “weather”, “today”, and “Louisville”, or “Weather today in Louisville?”) for an assistant action (e.g., search the Internet for the weather in Louisville today).

In some implementations, the NLU engine 135 can resolve the intent(s) and/or parameter(s) based on a single utterance of a user and, in other situations, prompts can be generated based on unresolved intent(s) and/or parameter(s). In this latter situation, the generated prompts can be rendered to the user to receive user response(s), where the user response(s) to the rendered prompt(s) can be utilized by the NLU engine 135 in resolving intent(s) and/or parameter(s). Optionally, the NLU engine 135 can work in concert with a dialog manager engine (not illustrated) that determines unresolved intent(s) and/or parameter(s). For instance, the dialog manager engine can be alternatively or additionally utilized to generate the aforementioned prompt(s). In some implementations, the NLU engine 135 can utilize one or more NLU machine learning models in determining intent(s) and/or parameter(s).

In various implementations, the fulfillment engine 137 of the cloud-based automated assistant application 13 (or a fulfillment engine of the client automated assistant application 112, which is not illustrated) can receive an intent and/or parameter(s) of the intent, to fulfill the intent by performing a corresponding assistant action. As a non-limiting example, the fulfillment engine 137 can receive the aforementioned intent of Internet search and the aforementioned search parameter of “Weather today in Louisville?”, to cause a search engine of the client computing device 11 to search the Internet for “Weather today in Louisville?”. In this example, the fulfillment engine 137 can fulfill the intent by: (1) causing the search engine to search the Internet for the user query, i.e., “Weather today in Louisville?”), (2) generating fulfillment information (e.g., “it's cloudy outside, with a temperature of 26° C.”), based on a search result (e.g., “Louisville, KY, Monday 11:00 am, cloudy, 26° C.”) of the search, and/or (3) rendering the fulfillment information to the user of the client computing device 11. As another non-limiting example, the fulfillment engine 137 can receive an intent and/or parameter(s) for an assistant action that causes a thermostat in the living room to set room temperature at 72 F. In this example, the fulfillment engine 137 can fulfill the intent by generating and forwarding a control signal to the thermostat in the living room, where the control signal causes the thermostat to set the room temperature at 72 F.

Optionally, when the NLU engine 135 cannot resolve the intent(s) and/or cannot determine all parameter(s) for the intent(s), to fulfill an assistant action, the fulfillment engine 137 can generate a default response, such as “Sorry, I don't understand. Please try again. In this case, the default response can be customized based on functions or a type of the client automated assistant application 112.

In some implementations, the TTS engine 133 can convert a text (e.g., the aforementioned fulfillment information of “it's cloudy outside, with a temperature of 26° C.”) to a synthesized speech using a particular voice. The synthesized speech, for instance, can be generated by using one or more trained speech synthesis neural network models to process the text. The synthesized speech can be audibly rendered via hardware speaker(s) of the client computing device 11 (e.g., a stand-alone speaker) or via another device (e.g., a cell phone).

In various implementations, the plurality of components of the cloud-based automated assistant application 13 can further include a suggestion engine 138. The suggestion engine 138 can include an overlay engine 1381, a criteria-retrieving engine 1382, a foreground-determining engine 1383, a suggestion-generating engine 1384, and/or a suggestion-rendering engine 1385. In some implementations, the overlay engine 1381 can determine a size and location for an overlay to be rendered within the user interface 1103 of the first application 110. As a non-limiting example, referring to FIG. 1, the overlay engine 1381 can determine that an overlay 171 is to be rendered at a bottom region of the user interface 1103, where the overlay 171 covers content that is within a portion of the user interface 1103 to which the overlay 171 corresponds. In some implementations, the overlay engine 1381 can cause the overlay 171 to be displayed, for instance, with the determined size and at the determined location within the user interface 1103 of the first application 110.

Optionally, the overlay engine 1381 can cause the overlay 171 to be displayed in response to detecting a user input that invokes an automated assistant application (including the client automated assistant application 112 and/or the cloud-based automated assistant application 13). For instance, the overlay engine 1381 can cause the overlay 171 to be displayed in response to detecting an assistant invocation while the first application 110 is running in a foreground of the client device 11, where the assistant invocation is from a user of the client device 11 and is to request one or more suggestions that suggest additional content or actions that are provided by the automated assistant application (or other applications such as the additional application 114).

Referring again to FIG. 1, the overlay 171 can include one or more suggestions 1711 (e.g., a first suggestion S−1, . . . , a X^{th} suggestion S−X, . . . , and a N^{th} suggestion S−N). The first suggestion S−1, for instance, can suggest an action of performing an Internet search for an inquiry. Alternatively, the first suggestion S−1 (or another suggestion such as the X^{th} suggestion S−X) can, for instance, suggest an action performable using a particular application, out of the additional application(s) 114, via the overlay 171. The particular application can be determined or selected, for instance, based on the aforementioned suggestion-generation criteria 1161 that is specific to (or determined by) the first application 110. As a non-limiting example, the suggestion-generation criteria 1161 can include a rule defining one or more application(s) (that are in addition to the first application 110) qualified as sources for content or action(s) suggested by the one or more suggestions. Alternatively or additionally, the suggestion-generation criteria 1161 can include a rule defining one or more application(s) (that are in addition to the first application 110) not qualified as sources for content or action(s) suggested by the one or more suggestions. More examples and descriptions of the suggestion-generation criteria 1161 can be found later in this disclosure.

In some implementations, a user of the client computing device 11 can invoke the client automated assistant application 112 while the first application 110 is running in a foreground of the client computing device 11, for one or more suggestions. Optionally, in these implementations, the overlay engine 1381 can cause the overlay 171 to be displayed within the user interface 1103, and the foreground-determining engine 1383 can determine a foreground context of the client computing device 11, where the foreground context indicates that the first application 110 is running at the foreground and/or other information (e.g., media content currently provided by the first application 110). Based on the foreground (e.g., including a package name of the first application 110) determined by the foreground-determining engine 1383, the criteria-retrieving engine 1382 of the cloud-based automated assistant application 13 can retrieve the suggestion-generation criteria 1161 that is specific to the first application 110.

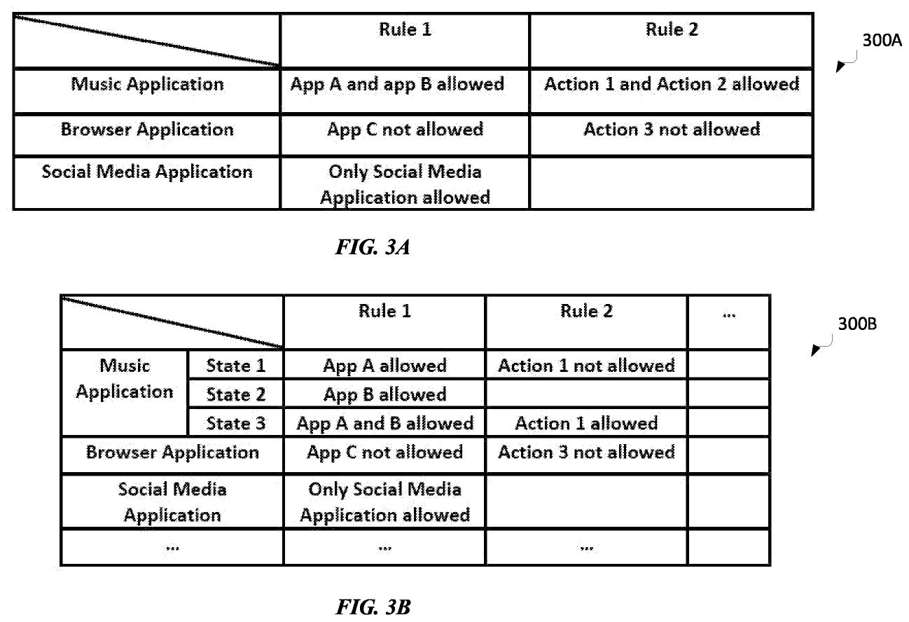

For instance, the criteria-retrieving engine 1382 of the cloud-based automated assistant application 13 can communicate with the first application 110 to request and retrieve the suggestion-generation criteria 1161. Alternatively, based on the package name of the first application 110 in the foreground context, the criteria-retrieving engine 1382 can access a criteria database 139 that is generated to include one or more suggestion-generation criteria each specific to a corresponding application. As a non-limiting example, the criteria database 139 can be, or include, a table (see FIG. 3A for a non-limiting example) listing a plurality of applications and suggestion-generation criteria for each of the plurality of application.

Alternatively or additionally, in some implementations, in response to the user of the client computing device 11 invoking the client automated assistant application 112 while the first application 110 is running in the foreground of the client computing device 11, the first application 110 can transmit the suggestion-generation criteria 1161 that is specific to the first application 110, to the client automated assistant application 112. In this case, the client automated assistant application 112 can transmit the suggestion-generation criteria 1161 that is specific to the first application 110, to the criteria-retrieving engine 1382 of the cloud-based automated assistant application 13.

In various implementations, the suggestion-generating engine 1384 can generate the one or more suggestions 1711 based on the suggestion-generation criteria 1161 that is specific to the first application 110 and/or content within the user interface 1103 of the first application 110. After the suggestion-generating engine 1384 generates the one or more suggestions, the suggestion-rendering engine 1385 can cause the one or more suggestions 1711 to be rendered within the overlay 171. For instance, a suggestion (e.g., the first suggestion S−1), of the one or more suggestions 1711, can be a selectable element, when selected by the user of the client computing device 11, cause an action suggested by the suggestion (e.g., the first suggestion S−1) to be performed by a corresponding application (e.g., the automated assistant application, one of the additional applications 114, or the first application 110 itself). In this case, the action can be performed by the corresponding application via the overlay 171, and the overlay 171 can be removed from the user interface 1103 after the action completes, or can be removed responsive to the user confirming that the action has been performed. Alternatively, a suggestion (e.g., the first suggestion S−1), of the one or more suggestions 1711, can be a selectable element, when selected by the user of the client computing device 11, cause content provided by a corresponding application (e.g., the automated assistant application, one of the additional applications 114, or the first application 110 itself) to be displayed.

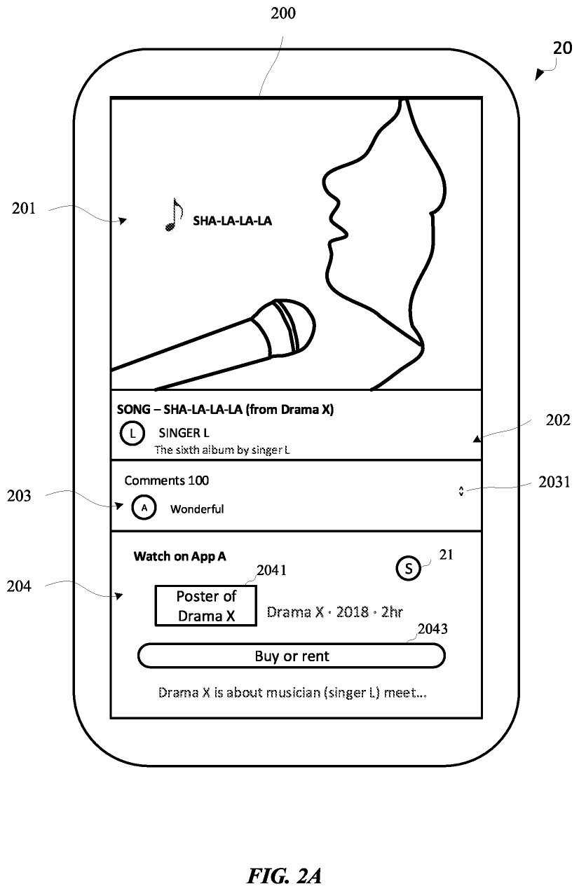

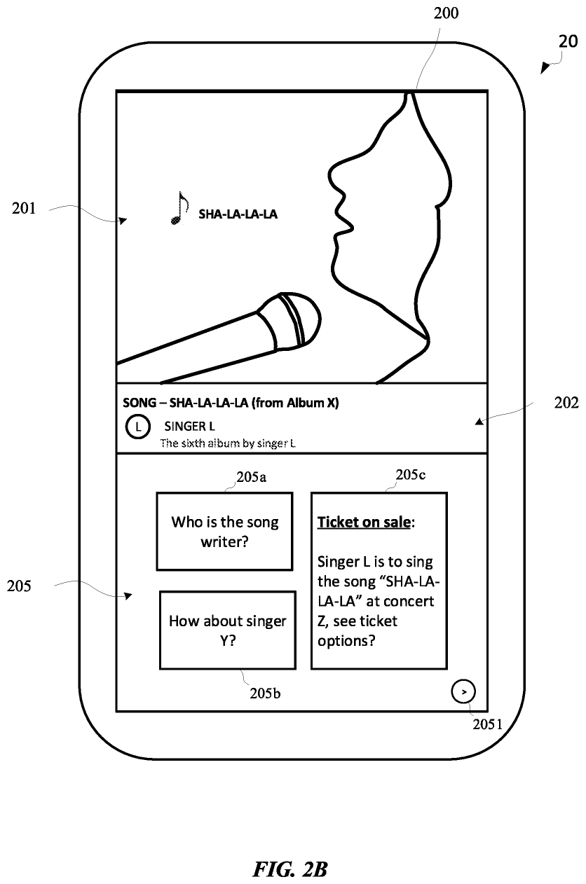

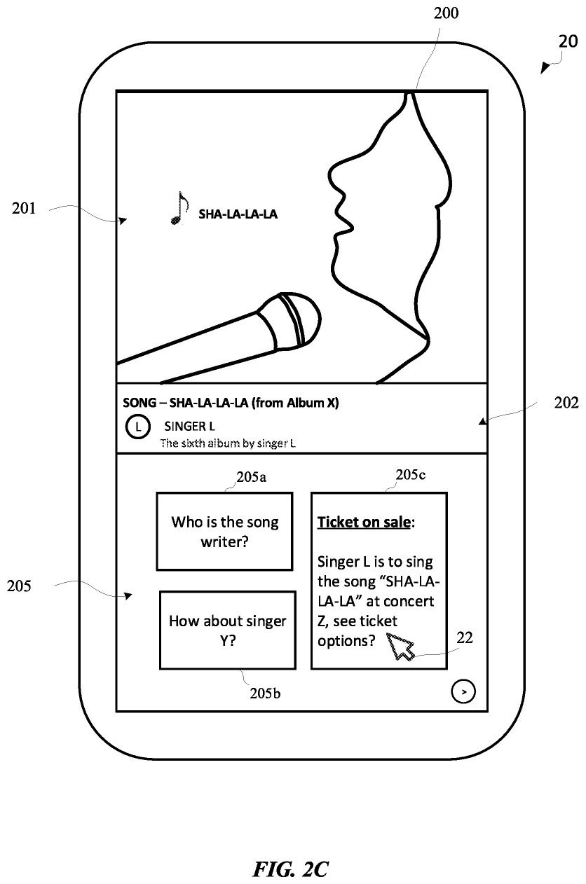

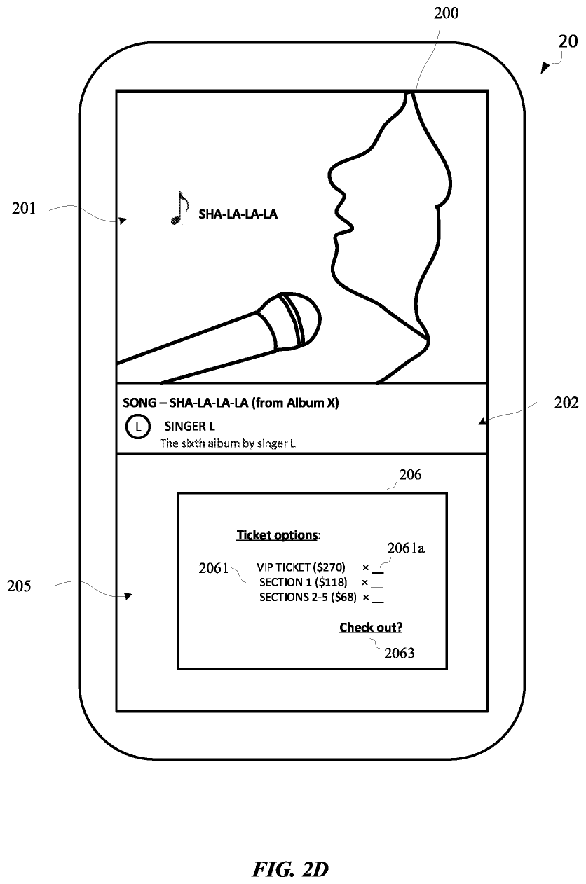

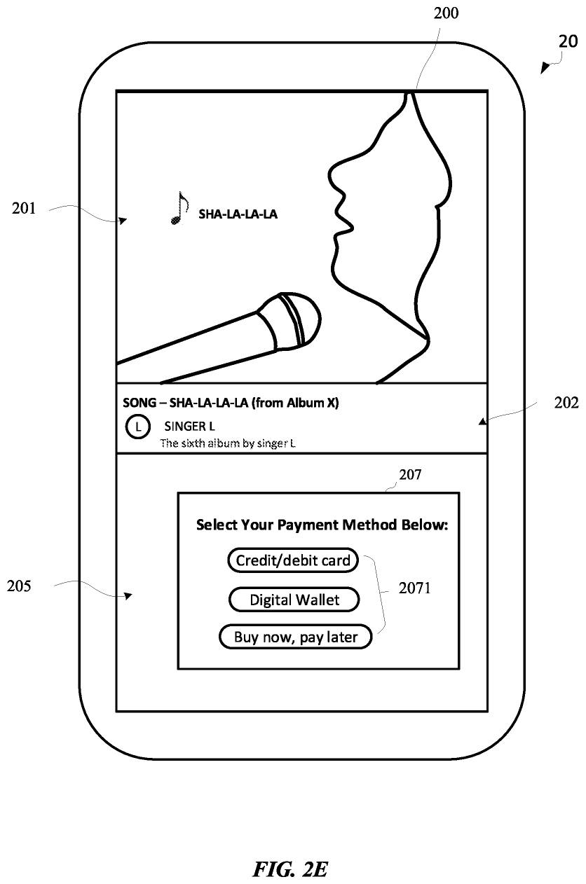

FIG. 2A depicts a non-limiting example of a user interface of an application running in a foreground of a client device, in accordance with various implementations. FIG. 2B depicts an example user interface of the application in FIG. 2A that includes an overlay to display one or more suggestions, in accordance with various implementations. FIG. 2C depicts an example user interface that includes the overlay that is updated in response to user selection of a suggestion of the one or more suggestions in FIG. 2B, in accordance with various implementations. FIG. 2D depicts an example user interface that includes the overlay that is further updated in response to user input subsequent to the user selection of the suggestion in FIG. 2C, in accordance with various implementations. FIG. 2E depicts an example user interface that includes the overlay that is additionally updated in response to additional user input, in accordance with various implementations.

Referring to FIG. 2, a user of a client device 20 can be listening to a song “SHA-LA-LA-LA” by singer “L” using a music application (which can be a non-limiting example of the first application 110 in FIG. 1), where a user interface 200 of the music application can include a first portion 201 displaying a video which shows that the singer L is singing the song “SHA-LA-LA-LA” at a concert. Optionally, the user interface 200 can further include a second portion 202 describing the song “SHA-LA-LA-LA”, and/or a third portion 203 displaying comments (e.g., 100 comments) to the song “SHA-LA-LA-LA”. In this case, as a non-limiting example, the second portion 202 can include a name of the song (i.e., “SHA-LA-LA-LA”), a name of the singer (i.e., singer L), a version of the song (i.e., from drama X), and/or an album (i.e., the sixth album by singer L) that collects the song. The third portion 203 can include, for instance, a comment from user A saying “Wonderful”, and/or a button 2031 that unfolds additional comments currently hidden from the user interface 200.

Optionally, the user interface 200 can further include a fourth portion 204 suggesting additional content provided by the music application and/or action(s) provided by the music application. For instance, the fourth portion 204 can suggest the user of the client computing device 11 to watch the Drama X (2018) which uses the song “SHA-LA-LA-LA” as soundtrack. Referring to FIG. 2A, the fourth portion 204 can include an official poster 2041 of Drama X, a length (e.g., 2h) for Drama X, and an introduction to Drama X, i.e., “Drama X is about seasoned musician (singer L) meet and . . . ” Additionally, the fourth portion 204 can include a selectable element 2043 that enables the user to watch Drama X by buying or renting Drama X, where the user can select the selectable element 2043 to further interact with the music application (i.e., to buy or rent Drama X).

Optionally, the user interface 200 can include a suggestion button 21 to invoke an automated assistant application (not shown) for one or more suggestions suggesting an action (or content) provided by one or more additional applications that are different from the music application, where the one or more additional applications can include the automated assistant application or other application(s). The suggestion button 21 can be displayed, for instance, within the first portion 201, the second portion 202, or another portion of the user interface 200, for selection by the user. In this case, when a user selects the suggestion button 21, the automated assistant application can be invoked to generate the one or more suggestions (see 205a and 205b in FIG. 2B), to be rendered within an overlay (see reference number 205 in FIG. 2B).

Alternatively, the suggestion button 21 may not be displayed within the user interface 200, and the automated assistant application can be invoked responsive to an invocation command (e.g., “Hey Assistant”) or user press on a physical button (or certain portion) of the client device 20, for further user interaction (e.g., user request for suggestions/suggested actions). Alternatively, the suggestion button 21 may not be displayed within the user interface 200, and the automated assistant application can respond to a voice request (e.g., “Assistant, could you recommend some actions?”) by causing the aforementioned overlay to be popped up, where the overlay can include the aforementioned one or more suggestions.

In some implementations, as a non-limiting example, in response to the user selecting the suggestion button 21, the automated assistant application can be invoked to determine a foreground context of the client device 20, where the foreground context can indicate or include a package name of the music application. Based on the package name of the music application, the automated assistant application can determine suggestion-generation criteria that is specific to the music application. For instance, the automated assistant application can access a rule table (in FIG. 3A) indexed using package names of different applications, to retrieve the suggestion-generation criteria that is specific to the music application. Based on the determined suggestion-generation criteria that is specific to the music application, the automated assistant application can generate the one or more suggestions.

Alternatively or additionally, the rule table can store suggestion-generation criteria that is specific to a corresponding state/mode of the music application. As a non-limiting example, the music application can have different states, such as a music-playing mode in which the music application streams song(s), a forum mode in which users of the music application exchange music knowledge or information via a music forum that is part of the music application, a news-sharing state in which the music application dynamically provides the latest news about singers and songs, etc. In this example, for different states of the music application, the rule table can store different rules being part of the suggestion-generation criteria that is specific to the music application. As a result, the applications or actions allowed (or not allowed) by the music application in the music-playing mode can be different from the applications or actions allowed (or not allowed) by the music application in the news-sharing state.

Referring to FIG. 2B, in response to the user selecting the suggestion button 21, the automated assistant application can cause an overlay 205 to be displayed within the user interface 200. For example, the overlay 205 can be displayed to cover the third and fourth portions 203 and 204, to show that the one or more suggestions can include, for instance, a first suggestion 205a, a second suggestion 205b, and a third suggestion 205c. Optionally, the overlay 205 can further include a button 2051, when selected, display one or more additional suggestions (e.g., a fourth suggestion) that are in addition to any suggestion (e.g., the first to third suggestions 205a˜205c) currently displayed with the overlay 205. The first suggestion 205a can be, for instance, a suggestion in natural language that suggests to search the Internet (or other database, such as an internal database of the music application searchable for information of singers, song writers, entertainment companies, etc.) for “Who is the song writer?”. The second suggestion 205b can be, for instance, a suggestion in natural language that suggests to search the Internet for “How about singer Y?” The third suggestion 205c can be, for instance, a suggestion that suggests an action of purchasing ticket(s), where the suggestion includes natural language content such as “Ticket on sale—Singer L is to perform the song ‘SHA-LA-LA-LA’ at concert Z, see ticket options?”

Optionally, the first suggestion 205a can include a symbol (not shown) or a name representing a browser that is to perform the Internet search for “Who is the song writer?”, where the symbol or the name representing the browser can be determined based on the suggestion-generation criteria that is specific to the music application. In other words, in this case, the browser is enabled by the music application to perform the corresponding Internet search, pursuant to the suggestion-generation criteria that is specific to the music application.

Optionally, the second suggestion 205b can include a symbol or a name representing the automated assistant application that is to perform the Internet search for “How about singer Y?”, based on the automated assistant application being allowed to perform such Internet search, pursuant to the suggestion-generation criteria that is specific to the music application.

Optionally, the third suggestion 205c can include a symbol or a name representing an application (e.g., ticketing application) that is to enable the user to perform the action of purchasing a ticket via the overlay 205, pursuant to the suggestion-generation criteria that is specific to the music application.

As shown in FIG. 2C, the user may select the third suggestion 205c by using a cursor 22 to click on the third suggestion 205c (or by audibly saying “Yes, see ticket options”). Referring to FIG. 2D, in response to the user selecting the third suggestion 205c, the overlay 205 can be updated to show an interface of ticket options 205′ that displays one or more ticket options 2051. For instance, the one or more ticket options can include price and/or location for a VIP ticket, price and/or location for a golden ticket, and/or price and/or location for a silver ticket. The one or more ticket options can further include a drop-down menu for each type of tickets (VIP, golden, or silver) that enables the user to select the corresponding ticket number to be added to a cart of the ticketing application. Optionally, the interface of ticket options 205′ can further include a selectable check-out element 2053, in addition to including the one or more ticket options. In this case, the user can select the selectable check-out element 2053 to check out the tickets added to the cart of the ticketing application.

As shown in FIG. 2E, in response to the user selecting the selectable check-out element 2053, the overlay 205 can be further updated to show an interface of payment option 205″. For instance, the interface of ticket options 205′ can be displaced with the interface of payment option 205″. The interface of the payment option 205″ can include one or more payment options for user selection, such as “Credit/debit card” payment option, “Digital Wallet” payment option, and/or “Buy now, pay later” payment option. Once the user selects one of the one or more payment options, the interface of payment option 205″ can be updated, for instance, to allow the user to input card information, so as to complete the action of purchasing ticket(s).

Optionally, after the action of purchasing ticket(s) completes, the overlay 205 can be removed/dismissed from the user interface 200. For instance, after the overlay 205 is removed, the user interface 200 can again display the third and fourth portions 203 and 204, which were once hidden due to the display/pop-up of the overlay 205. Optionally, the overlay 205 can be removed automatically in response to the completion of the action of purchasing ticket(s). Alternatively, the overlay 205 can be removed in response to the user confirming that the action of purchasing ticket(s) has been completed. Alternatively, the overlay 205 can be removed at a moment when a predetermined period of time has passed since the action of purchasing ticket(s) completes and no user interaction with the overlay 205 is received during the predetermined period of time. The overlay 205 can be removed using other approaches, and the present disclosure is not limited to descriptions provided herein.

FIG. 3A depicts an example database storing suggestion-generation criteria for a plurality of applications, in accordance with various implementations. As shown in FIG. 3A, the database storing suggestion-generation criteria can be a table 300A indexed with a plurality of application names, where for each application name, the table 300A stores suggestion-generation criteria defined by an application having a corresponding application name. For instance, the table 300A can include an entry for a music application, where the entry for the music application includes: a package name (or application name or other identifier) of the music application, and the suggestion-generation criteria specific to the music application. As shown in FIG. 3A, the suggestion-generation criteria specific to the music application can include a first rule defining one or more applications allowed to provide content or action to be suggested via an overlay (e.g., overlay 205 in FIG. 2B) of the music application. In this case, the suggestion-generation criteria can, for instance, further include a second rule defining one or more actions allowed to be suggested via the overlay of the music application.

Referring again to FIG. 3A, the table 300A can include an entry for a browser application, where the entry for the browser application includes: a package name (or application name or other identifier) of the browser application, and the suggestion-generation criteria specific to the browser application. For instance, the suggestion-generation criteria specific to the browser application can include a first rule defining one or more applications not allowed to provide content or action to be suggested via an overlay on top of a user interface of the browser application. Alternatively or additionally, the suggestion-generation criteria specific to the social media application can include a second rule defining one or more actions not allowed to be suggested via the overlay of the browser application.

Optionally, Referring again to FIG. 3A, the table 300A can include an entry for a social media application, where the entry for the social media application includes: a package name (or application name or other identifier) of the social media application, and the suggestion-generation criteria specific to the social media application. For instance, the suggestion-generation criteria specific to the social media application can include a first rule defining that the social media application itself is the only source for action to be suggested via an overlay on top of a user interface of the social media application. Alternatively or additionally, the suggestion-generation criteria specific to the social media application can include a second rule defining actions allowed and/or actions not allowed to be suggested via the overlay of the social media application. It's noted that the examples and descriptions provided above or below are for the purpose of illustration, and are not intended to be limiting.

FIG. 3B depicts another example database storing suggestion-generation criteria for a plurality of applications, in accordance with various implementations. As shown in FIG. 3B, the database storing suggestion-generation criteria can be a table 300B indexed with a plurality of application names, where for each application name, the table 300B stores suggestion-generation criteria defined by an application having a corresponding application name. For instance, the table 300B can include an entry for a music application having one or more states (e.g., state 1, state 2, and state 3), where the entry for the music application includes: a package name (alternatively an application name such as “GreatMusicToday”, or other identifier that identifies the music application) of the music application. In this instance, the entry for the music application can further include suggestion-generation criteria specific to each state of the music application.

Referring to FIG. 3B, the suggestion-generation criteria specific to “State 1” of the music application can include a first rule (“Rule 1)” defining “App A” is allowed to provide content or action to be suggested via an overlay (e.g., overlay 205 in FIG. 2B) of the music application. In this case, the suggestion-generation criteria can, for instance, further include a second rule (“Rule 2”) defining that “Action 1” is not allowed to be suggested via the overlay of the music application. Similarly, the suggestion-generation criteria specific to “State 2” of the music application can include a first rule (“Rule 1)” defining “App B” is allowed to provide content or action to be suggested via the overlay of the music application. Similarly, the suggestion-generation criteria specific to “State 3” of the music application can include: a first rule defining “App A and App B” are allowed to provide content or action(s) to be suggested via the overlay of the music application, and a second rule defining that “Action 1” is allowed to be suggested via the overlay of the music application. Repeated descriptions for the rest portion of table 300B are omitted herein. It's noted that optionally, the browser application and the social media application listed in table 300B (or other application not specifically illustrated in table 300B) can each have one or more states, and table 300B can store suggestion-generation criteria specific to each state, of the one or more states, for any application listed in table 300B.

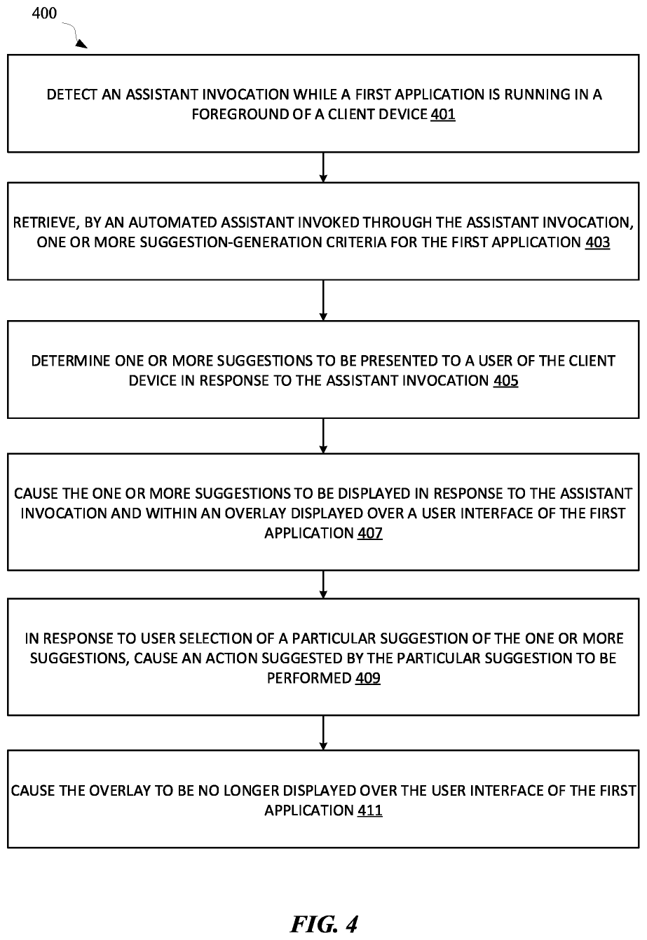

FIG. 4 illustrates a flowchart illustrating an example method 400 for generating one or more suggestions for display within an overlay of a particular application based on suggestion-generation criteria specific to the particular application, in accordance with various implementations. For convenience, the operations of the method 400 are described with reference to a system that performs the operations. The system of method 400 includes one or more processors and/or other component(s) of a client device and/or of a server device. Moreover, while operations of the method 400 are shown in a particular order, this is not meant to be limiting. One or more operations may be reordered, omitted, or added.

Referring to FIG. 4, in various implementations, at block 401, the system can detect an assistant invocation while a first application is running in a foreground of a client device. As described above, the first application can be a music application or any other applicable application that is installed at the client device, or otherwise accessible via the client device. The client device, for instance, can be a smart phone, a laptop, an in-vehicle entertainment system, or any other applicable computing device. The assistant invocation can be received from a user of the client device, and is to request one or more suggestions to be displayed via an overlay or a pop-up window of a user interface of the first application. As a non-limiting example, the assistant invocation can be the user speaking, “Hey Assistant, any recommendations?”. Alternatively, as another non-limiting example, the assistant invocation can be a user selection of a selectable element graphically displayed within the user interface of the first application, where the selectable element is configured to trigger the one or more suggestions.

As a practical example, the system can detect the assistant invocation by: (i) receiving, via the first application, an indication of a user selection of a selectable element, for suggesting one or more actions, that is displayed at a user interface of the first application, and (ii) detecting the assistant invocation in response to receiving the indication of the user selection of the selectable element.

In various implementations, at block 403, the system can retrieve, by an automated assistant application and from the first application running in the foreground of the client device, one or more suggestion-generation criteria for the first application. The one or more suggestion-generation criteria can be defined by the first application, or can be customized to be specific to the first application. As a non-limiting example, the one or more suggestion-generation criteria can be, or can include, a first rule defining application(s) allowed to provide content or action to be suggested via an overlay on top of a user interface of the first application, and/or application(s) not allowed to content or action to be suggested via the overlay on top of the user interface of the first application.

As another non-limiting example, the one or more suggestion-generation criteria can be, or can include, a second rule defining content or action allowed to be suggested via the overlay on top of the user interface of the first application, and/or content or action not allowed to be suggested via the overlay on top of the user interface of the first application. It's noted that for different applications, the one or more suggestion-generation criteria can be different. In some implementations, the automated assistant application can create a database (e.g., the table 300 in FIG. 3, or the criteria database 139 of the cloud-based automated assistant application 13 in FIG. 1) to store the suggestion-generation criteria for each of a plurality of applications that are installed at, or accessible via, the client device. Optionally, the automated assistant application can update the database in response to detecting a change to the suggestion-generation criteria for a particular application, of the plurality of applications.

Alternatively or additionally, the one or more suggestion-generation criteria for the first application can be specific to a particular state of the first application. Optionally, the one or more suggestion-generation criteria for the first application can be provided by the first application responsive to a current state of the first application at a time of the assistant invocation being the particular state.

In some implementations, the system retrieves the one or more suggestion-generation criteria from the first application in response to detecting the assistant invocation and in response to the first application being running in the foreground when the assistant invocation is detected.

Optionally, the system can retrieve the one or more suggestion-generation criteria from the first application by: (1) providing, via an operating system of the client device, a suggestion-generation criteria request to the first application; and (2) receiving the suggestion-generation criteria via the operating system and responsive to the suggestion-generation criteria request.

In various implementations, at block 405, the system can determine, by the automated assistant application and based on the one or more suggestion-generation criteria retrieved from the first application, one or more suggestions to be presented to a user of the client device in response to the assistant invocation. The one or more suggestions, for instance, can be or can include, a suggestion that suggests an action to be performed by a second application, via the overlay of the first application.

The second application can be determined based on the one or more suggestion-generation criteria retrieved from the first application, and can be the same as or different from the first application. For instance, the second application can be the automated assistant application, or another application that is different from the first application. It's noted that the system determines the one or more suggestions based on the first application being running in the foreground when the assistant invocation is detected.

In various implementations, at block 407, the system can cause the one or more suggestions to be displayed in response to the assistant invocation and within the overlay displayed over the user interface of the first application. The size and/or location of the overlay can be determined by the automated assistant application. Alternatively, the size and/or location of the overlay can be determined by the first application and/or the automated assistant application. For instance, the first application can transmit a message indicating an allowed size range and/or allowed location for the overlay to the automated assistant application in response to the automated assistant application being invoked. As another instance, the first application can transmit a message indicating an allowed size range and/or allowed location for the overlay to the automated assistant application in response to the automated assistant application requesting such information from the first application.

Optionally, in some implementations, the system can further receive a user selection of a particular suggestion, of the one or more suggestions displayed within the overlay. Optionally, in some implementations, at block 409, the system can, in response to receiving the user selection of the particular suggestion: cause an action corresponding to the particular suggestion to be performed, and cause the overlay that displays the one or more suggestions to no longer be displayed over the user interface of the first application.

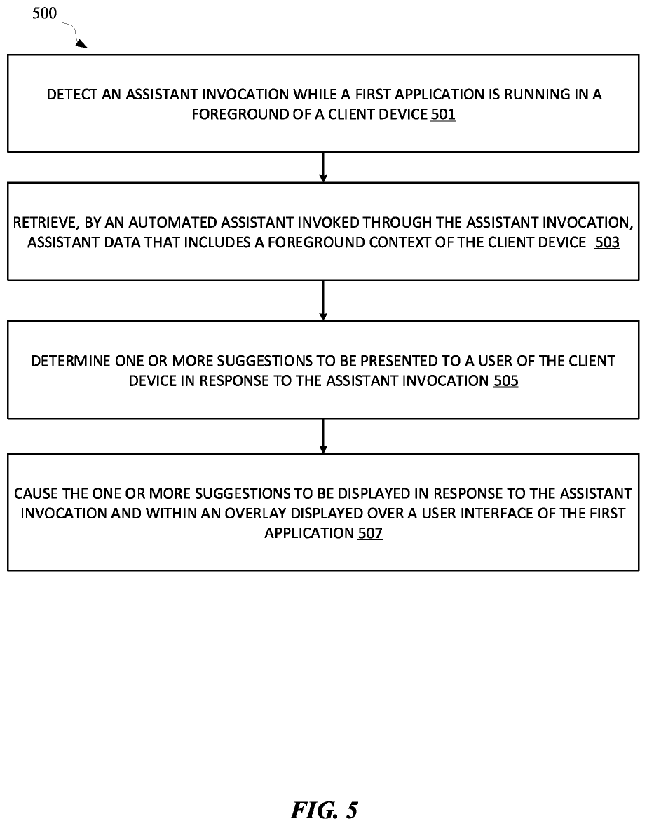

FIG. 5 is a flowchart illustrating an additional example method 500 for generating one or more suggestions, in accordance with various implementations. For convenience, the operations of the method 400 are described with reference to a system that performs the operations. The system of method 400 includes one or more processors and/or other component(s) of a client device and/or of a server device. Moreover, while operations of the method 400 are shown in a particular order, this is not meant to be limiting. One or more operations may be reordered, omitted, or added.

In various implementations, at block 501, the system can detect an assistant invocation while a first application is running in a foreground of a client device. As described above, the first application can be a music application or any other applicable application that is installed at the client device, or otherwise accessible via the client device. The client device, for instance, can be a smart phone, a laptop, an in-vehicle entertainment system, or any other applicable computing device. The assistant invocation can be received from a user of the client device, and is to request one or more suggestions to be displayed via an overlay or a pop-up window of a user interface of the first application. As a non-limiting example, the assistant invocation can be the user speaking, “Hey Assistant, any recommendations?”. Alternatively, as another non-limiting example, the assistant invocation can be a user selection of a selectable element graphically displayed within the user interface of the first application, where the selectable element is configured to trigger the one or more suggestions.

For instance, the system can detect the assistant invocation by: (i) receiving, via the first application, an indication of a user selection of a selectable element, for suggesting one or more actions, that is displayed at a user interface of the first application, and (ii) detecting the assistant invocation in response to receiving the indication of the user selection of the selectable element.

In various implementations, at block 503, the system can retrieve, by an automated assistant application, a foreground context of the client device indicating that the first application is running in the foreground of the client device. The foreground context of the client device, for instance, can include at least a package name of the first application. Optionally, the foreground context of the client device can further indicate a state of the first application. For instance, the foreground context of the client device can further indicate current content provided by the first application, or a mode that the first application is currently in.

In various implementations, at block 505, the system can determine, via the automated assistant application and based at least on the retrieved foreground context of the client device, one or more suggestions to be presented to a user of the client device. The system can determine the one or more suggestions based at least on the retrieved foreground context of the client device indicating that the first application is running in the foreground when the assistant invocation is detected.

Optionally, the system can determine the one or more suggestions to be presented to the user of the client device by: retrieving, via the automated assistant application and based on the retrieved foreground context of the client device indicating that the first application is running in the foreground when the assistant invocation is detected, automated assistant data (e.g., data from the criteria database 139 in FIG. 1) that describes suggestion-generation criteria (e.g., one or more actions allowed by the first application) that is specific to the first application; and determining, based on the retrieved foreground context of the client device and the suggestion-generation criteria specific to the first application, the one or more suggestions.

Optionally, the suggestion-generation criteria can include a rule that defines one or more applications or actions that are not allowed by the first application.

Optionally, the suggestion-generation criteria generated by the first application include: package names of one or more additional applications that are different from the first application. In this case, for example, the system can determine the one or more suggestions to be presented to the user of the client device by: retrieving, via the automated assistant application, automated assistant data that describes one or more actions associated with the one or more additional applications, and determining, based on the foreground context of the client device and the one or more actions associated with the one or more additional applications, the one or more suggestions.

Optionally, the suggestion-generation criteria specific to the first application can include: one or more actions performable via the automated assistant application.

Optionally, the suggestion-generation criteria specific to the first application can include: one or more actions performable via one or more applications that are different from the first application.

In various implementations, at block 507, the system can cause the one or more suggestions to be displayed in response to the assistant invocation and within an overlay displayed over a user interface of the first application. The size and/or location of the overlay can be determined by the automated assistant application. Alternatively, the size and/or location of the overlay can be determined by the first application and/or the automated assistant application. For instance, the first application can transmit a message indicating an allowed size range and/or allowed location for the overlay to the automated assistant application in response to the automated assistant application being invoked. As another instance, the first application can transmit a message indicating an allowed size range and/or allowed location for the overlay to the automated assistant application in response to the automated assistant application requesting such information from the first application.

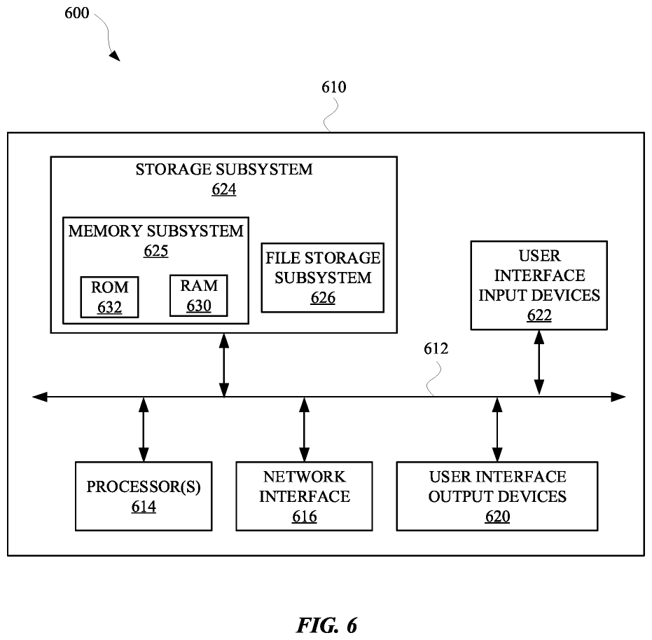

FIG. 6 is a block diagram of an example computing device 610 that may optionally be utilized to perform one or more aspects of techniques described herein. In some implementations, one or more of a client computing device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

In various implementations, a method implemented by one or more processors is provided, and includes: detecting an assistant invocation while a first application is running in a foreground of a client device; retrieving by an automated assistant and from the first application running in the foreground of the client device, one or more suggestion-generation criteria for the first application; and determining, by the automated assistant and based on the one or more suggestion-generation criteria retrieved from the first application, one or more suggestions to be presented to a user of the client device in response to the assistant invocation. In some implementations, determining the one or more suggestions based on the suggestion-generation criteria retrieved from the first application, can be based on the first application being running in the foreground when the assistant invocation is detected.

In some implementations, the method can further include: causing the one or more suggestions to be displayed in response to the assistant invocation and within an overlay displayed over a user interface of the first application. In some implementations, the method can further include: receiving a user selection of a particular suggestion, of the one or more suggestions displayed within the overlay. In this case, in response to receiving the user selection of the particular suggestion, the method can further include: causing an action corresponding to the particular suggestion to be performed, and causing the overlay that displays the one or more suggestions to no longer be displayed over the user interface of the first application.

In some implementations, retrieving the one or more suggestion-generation criteria from the first application can be in response to detecting the assistant invocation and can be in response to the first application being running in the foreground when the assistant invocation is detected. In these implementations, the one or more suggestion-generation criteria for the first application can be specific to a state of the first application and can be provided by the first application responsive to the state being a current state of the first application at a time of the assistant invocation.

In some implementations, retrieving the one or more suggestion-generation criteria from the first application can include: providing, via an operating system of the client device, a suggestion-generation criteria request to the first application; and receiving the suggestion-generation criteria via the operating system and responsive to the suggestion-generation criteria request.

In some implementations, detecting the assistant invocation include: receiving, via the first application, an indication of a user selection of a selectable element, for suggesting one or more actions, that is displayed at a user interface of the first application; and detecting the assistant invocation in response to receiving the indication of the user selection of the selectable element.

In some implementations, the one or more suggestion-generation criteria includes a package name of the first application. Alternatively or additionally, the one or more suggestion-generation criteria includes a rule that defines one or more applications or actions that are not allowed by the first application.

In various implementations, a method implemented by one or more processors is provided, and includes: detecting an assistant invocation while a first application is running in a foreground of a client device; retrieving, by an automated assistant, a foreground context of the client device indicating that the first application is running in the foreground of the client device; determining, via the automated assistant and based at least on the retrieved foreground context of the client device, one or more suggestions to be presented to a user of the client device. In these implementations, determining the one or more suggestions can be based at least on the retrieved foreground context of the client device indicating that the first application is running in the foreground when the assistant invocation is detected. The method described in these implementations can further include: causing the one or more suggestions to be displayed in response to the assistant invocation and within an overlay displayed over a user interface of the first application.

In some implementations, the foreground context of the client device includes at least a package name of the first application. Alternatively or additionally, the foreground context of the client device includes content displayed via the user interface of the first application.

In some implementations, determining the one or more suggestions to be presented to the user of the client device include: retrieving, via the automated assistant and based on the retrieved foreground context of the client device indicating that the first application is running in the foreground when the assistant invocation is detected, automated assistant data that describes suggestion-generation criteria specific to the first application; and determining, based on the retrieved foreground context of the client device and suggestion-generation criteria specific to the first application, the one or more suggestions. In these implementations, the suggestion-generation criteria can include a rule that defines one or more applications or actions that are not allowed by the first application.

Alternatively or additionally, the suggestion-generation criteria generated by the first application can include: package names of one or more additional applications that are different from the first application. In these implementations, determining the one or more suggestions to be presented to the user of the client device can include: retrieving, via the automated assistant, automated assistant data that describes one or more actions associated with the one or more additional applications; and determining, based on the foreground context of the client device and the one or more actions associated with the one or more additional applications, the one or more suggestions.

In some implementations, the suggestion-generation criteria specific to the first application can include: one or more actions performable via the automated assistant. Alternatively or additionally, the suggestion-generation criteria specific to the first application can include: one or more actions performable via one or more applications that are different from the first application.

In various implementations, a system is provided and includes: one or more processors; and one or more memories storing instructions that, when executed by the one or more processors, cause the one or more processors to perform a plurality of operations. The plurality of operations can include: detecting an assistant invocation while a first application is running in a foreground of a client device; retrieving by an automated assistant and from the first application running in the foreground of the client device, one or more suggestion-generation criteria for the first application; determining, by the automated assistant and based on the one or more suggestion-generation criteria retrieved from the first application, one or more suggestions to be presented to a user of the client device in response to the assistant invocation. In these implementations, the operation of determining the one or more suggestions based on the suggestion-generation criteria retrieved from the first application can be based on the first application being running in the foreground when the assistant invocation is detected. The plurality of operations in these implementations can further include: causing the one or more suggestions to be displayed in response to the assistant invocation and within an overlay displayed over a user interface of the first application.

In some implementations, retrieving the one or more suggestion-generation criteria from the first application can be in response to detecting the assistant invocation and is in response to the first application being running in the foreground when the assistant invocation is detected.

In some implementations, the one or more suggestion-generation criteria for the first application can be specific to a particular state of the first application and can be provided by the first application responsive to a current state of the first application at a time of the assistant invocation being the particular state.

1. A computer-implemented method, comprising:
detecting an assistant invocation while a first application is running in a foreground of a client device;
retrieving by an automated assistant and from the first application running in the foreground of the client device, one or more suggestion-generation criteria for the first application;
determining, by the automated assistant and based on the one or more suggestion-generation criteria retrieved from the first application, one or more suggestions to be presented to a user of the client device in response to the assistant invocation, wherein the one or more suggestion-generation criteria include a rule that identifies one or more additional applications allowed by the first application as a source for content or an action suggested in the one or more suggestions that are to be presented via the first application,
wherein determining the one or more suggestions based on the one or more suggestion-generation criteria retrieved from the first application, is based on the first application being running in the foreground when the assistant invocation is detected; and
causing the one or more suggestions to be displayed in response to the assistant invocation and within an overlay displayed over a user interface of the first application.

2. The method of claim 1, wherein retrieving the one or more suggestion-generation criteria from the first application is in response to detecting the assistant invocation and is in response to the first application being running in the foreground when the assistant invocation is detected.

3. The method of claim 2, wherein the one or more suggestion-generation criteria for the first application are specific to a state of the first application and are provided by the first application responsive to the state being a current state of the first application at a time of the assistant invocation.

4. The method of claim 1, wherein retrieving the one or more suggestion-generation criteria from the first application comprises:
providing, via an operating system of the client device, a suggestion-generation criteria request to the first application; and
receiving the one or more suggestion-generation criteria via the operating system and responsive to the suggestion-generation criteria request.

5. The method of claim 1, further comprising:
receiving a user selection of a particular suggestion, of the one or more suggestions displayed within the overlay, and
in response to receiving the user selection of the particular suggestion:
causing a particular action corresponding to the particular suggestion to be performed, and
causing the overlay that displays the one or more suggestions to no longer be displayed over the user interface of the first application.

6. The method of claim 1, wherein detecting the assistant invocation comprises:
receiving, via the first application, an indication of a user selection of a selectable element, for suggesting one or more actions, that is displayed at a user interface of the first application, and
detecting the assistant invocation in response to receiving the indication of the user selection of the selectable element.

7. The method of claim 1, wherein retrieving the one or more suggestion-generation criteria includes: retrieving the one or more suggestion-generation criteria using a package name of the first application.

8. The method of claim 1, wherein the one or more suggestion-generation criteria includes a rule that defines one or more applications or actions that are not allowed by the first application.

9. A computer-implemented method, comprising:
detecting an assistant invocation from a user that is directed to an automated assistant and that requests suggestions while a first application is running in a foreground of a client device;
retrieving, by the automated assistant that is different from the first application, a foreground context of the client device indicating that the first application is running in the foreground of the client device;
determining, via the automated assistant and based at least on the retrieved foreground context of the client device, one or more suggestions to be presented to a user of the client device;
wherein determining the one or more suggestions is based at least on the retrieved foreground context of the client device indicating that the first application is running in the foreground when the assistant invocation is detected; and
causing the one or more suggestions to be displayed in response to the assistant invocation and within an overlay displayed over a user interface of the first application.

10. The method of claim 9, wherein the foreground context of the client device includes at least a package name of the first application.

11. The method of claim 9, wherein the foreground context of the client device includes content displayed via the user interface of the first application.

12. The method of claim 9, wherein determining the one or more suggestions to be presented to the user of the client device comprises:
retrieving, via the automated assistant and based on the retrieved foreground context of the client device indicating that the first application is running in the foreground when the assistant invocation is detected, automated assistant data that describes suggestion-generation criteria specific to the first application, and
determining, based on the retrieved foreground context of the client device and the suggestion-generation criteria specific to the first application, the one or more suggestions.

13. The method of claim 12, wherein the suggestion-generation criteria include a rule that defines one or more applications or actions that are not allowed by the first application.

14. The method of claim 12, wherein the suggestion-generation criteria generated by the first application include: package names of one or more additional applications that are different from the first application.

15. The method of claim 14, wherein determining the one or more suggestions to be presented to the user of the client device comprises:
retrieving, via the automated assistant, automated assistant data that describes one or more actions associated with the one or more additional applications, and
determining, based on the foreground context of the client device and the one or more actions associated with the one or more additional applications, the one or more suggestions.

16. The method of claim 12, wherein the suggestion-generation criteria specific to the first application include: one or more actions performable via the automated assistant.

17. The method of claim 12, wherein the suggestion-generation criteria specific to the first application include: one or more actions performable via one or more applications that are different from the first application.

18. A system, comprising:
one or more processors; and
one or more memories storing instructions that, when executed by the one or more processors, cause the one or more processors to perform operations comprising:
detecting an assistant invocation while a first application is running in a foreground of a client device,
retrieving by an automated assistant and from the first application running in the foreground of the client device, one or more suggestion-generation criteria for the first application,
determining, by the automated assistant and based on the one or more suggestion-generation criteria retrieved from the first application, one or more suggestions to be presented to a user of the client device in response to the assistant invocation, wherein the one or more suggestion-generation criteria include a rule that identifies one or more additional applications allowed by the first application as a source for content or an action suggested in the one or more suggestions that are to be presented via the first application,
wherein determining the one or more suggestions based on the one or more suggestion-generation criteria retrieved from the first application, is based on the first application being running in the foreground when the assistant invocation is detected; and
causing the one or more suggestions to be displayed in response to the assistant invocation and within an overlay displayed over a user interface of the first application.

19. The system of claim 18, wherein retrieving the one or more suggestion-generation criteria from the first application is in response to detecting the assistant invocation and is in response to the first application being running in the foreground when the assistant invocation is detected.

20. The system of claim 18, wherein the one or more suggestion-generation criteria for the first application are specific to a particular state of the first application and are provided by the first application responsive to a current state of the first application at a time of the assistant invocation being the particular state.
